(19) United States
(12) Patent Application Publication
(10) Pub. No.: US 2010/0218469 A1
(43) Pub. Date: Sep. 2, 2010

(54) BAG FILTER AND METHOD FOR ITS CONSTRUCTION

(75) Inventor: Giorgio Radaelli, Cernusco sul Naviglio (IT)

Correspondence Address: HUSCH BLACKWELL SANDERS LLP, 190 Carondelet Plaza, Suite 600, ST. LOUIS, MO, 63105, US

(73) Assignee: RD42 TECHNOLOGIES S.R.L. A SOCIO UNICO, Cernusco sul Naviglio (IT)

(21) Appl. No.: 12/681,099

(22) PCT Filed: Oct. 2, 2008
(86) PCT No.: PCT/IB08/02609

§ 371 Date: Mar. 31, 2010

(30) Foreign Application Priority Data
Oct. 2, 2007 (IT) MI2007A001880

(51) Int. Cl. B01D 46/02; B23P 11/00

(52) U.S. Cl. 55/378; 55/361; 29/428

(57) ABSTRACT

A bag filter (100) comprises a plurality of functional modules (1-4) associated with each other and adapted to perform respective functions in the bag filter. One or more functional modules (1-4) of said plurality of functional modules (1-4) have a respective structure obtained at least partially from one or more freight containers (10). A method for constructing such a bag filter (100) is also described.

### FIELD OF THE INVENTION

The present invention refers to a bag filter and a method for its construction.

### PRIOR ART

Bag filters are devices adapted to carry out the purification of a gaseous substance from dust suspended therein by means of passage through porous membranes, generally cylindrical in shape and arranged in parallel with each other with respect to the gaseous substance flow, commonly known as “bags”.

Typically, the functions carried out in a bag filter comprise: the collection of the gaseous substance to be filtered and its distribution on the bags, the filtration of the gaseous substance by means of its passage through the bags, the collection and evacuation of the extracted dusts, the collection and conveyance of the purified gaseous substance towards an exit section.

From a structural point of view, the known bag filters comprise one or more enclosures connected with each other, which contain a plurality of components related to the aforementioned functions. Specifically, a bag filter normally comprises one or more hoppers for collecting the extracted dust, one or more chambers containing the filtration bags, possibly subdivided in several compartments which may be taken on or off line selectively depending on the operational needs, a volume for collecting the filtered gaseous substance, also known as “plenum”, and a bag plate or perforated plate, used both as a support for the filtering bags and to separate the volumes of filtered and unfiltered gaseous substance. Auxiliary components may also be provided such as support and/or access structures for the different components, lighting devices and a variety of instrumentation.

The known bag filters are structurally built out of panels, either self-supporting or supported by frames, which are assembled by mechanical fastening, sealing and/or welding. This process takes place, either partially or entirely, in the workshop or at the installation site. Construction may be realised in a single unit or at least partially in a modular way, by assembling previously provided modules adapted to carry out, either individually or in groups, one ore more of the aforementioned functions.

### SUMMARY OF THE INVENTION

The technical problem underlying the present invention is to provide a bag filter of modular conception that can be constructed in a simple, rapid and economical way.

This problem is solved in the present invention by a bag filter with the characteristics described in appended claim 1, and by a construction method of the same comprising the steps cited in appended claim 15.

In particular, in a first aspect thereof, the invention refers to a bag filter comprising a plurality of functional modules associated with each other and adapted to perform respective functions in the bag filter, characterised in that one or more of said plurality of functional modules have a respective structure obtained at least partially from one or more freight containers.

In the context of the present description and of the subsequent claims, the term “freight container” is used to indicate an enclosure with a volume of at least 1 m³, adapted to the transport of goods, conceived for repeated use and designed to facilitate all the steps of goods displacement, in particular within the framework of intermodal freight transport.

By employing at least partially pre-existing structures which by their own nature are adapted to form modules, the provision of the functional modules of the bag filter of the invention is considerably simplified and sped up. This in turn affects in a favourable way the whole construction process of the bag filter, in terms of both simplicity and speed, and facilitates all the auxiliary steps of transport, assembly and, when required, disassembly of the bag filter. Furthermore, since decommissioned but structurally functional freight container are readily and economically available, the construction costs can be significantly reduced.

Preferred characteristics of the bag filter of the invention form the object of dependent claims 2-14, the content of which is herein fully incorporated by reference.

In a second aspect thereof, the present invention refers to a method for constructing a bag filter comprising a plurality of functional modules associated with each other and adapted to perform respective functions in the bag filter, said method comprising the steps of:
providing a plurality of functional modules of the bag filter,
assembling the provided functional modules with each other,
   characterised in that said step of providing a plurality of functional modules comprises the step of:
structurally modifying at least partially one or more freight containers in such a way as to obtain the structure of one or more functional modules of said plurality of functional modules.

Similarly to what stated above about the first aspect of the invention, this method allows the construction of bag filters in a simple, rapid and economical manner.

Preferred characteristics of the method for constructing a bag filter form the object of dependent claims 16-20, the content of which is herein fully incorporated by reference.

### BRIEF DESCRIPTION OF THE FIGURES

Further characteristics and advantages of the present invention shall become clearer from the following description of some preferred embodiments thereof, made hereafter, for indicating and non limiting purposes, with reference to the accompanying drawings. In these drawings:

FIG. 1 is a schematic perspective view of a first preferred embodiment of the bag filter of the invention;

FIG. 2 is a schematic perspective view with partially removed parts of the bag filter shown in FIG. 1;

FIGS. 3-5 are schematic views of respective further embodiments of the bag filter of the invention;

FIGS. 6a-6f are schematic perspective views of as many functional modules employable in the construction of the bag filters shown in FIG. 1 and in FIGS. 3-5;

FIG. 7 is a schematic perspective view of a further preferred embodiments of the bag filter of the invention;

FIGS. 8a-8c are schematic perspective views of as many functional modules employable in the construction of the bag filter shown in FIG. 7, and

FIG. 9 is a schematic perspective view with partially removed parts of a further preferred embodiment of the bag filter of the invention.

### DETAILED DESCRIPTION OF SOME PREFERRED EMBODIMENTS OF THE INVENTION

In such figures a bag filter according to invention is globally indicated with reference numeral 100.

The bag filter 100 comprises a plurality of functional modules 1-4 associated with each other and adapted to perform respective functions within the bag filter.

In particular, in the examples illustrated herein, the bag filter 100 comprises a support module 1, a dust collection module 2, a filtration module 3 and a collection module for the filtered gaseous substance or plenum 4, the features of which shall be better illustrated in the remainder.

According to the present invention, the functional modules 1-4 have a respective structure at least partially obtained from one or more freight containers, generically indicated with the reference numeral 10.

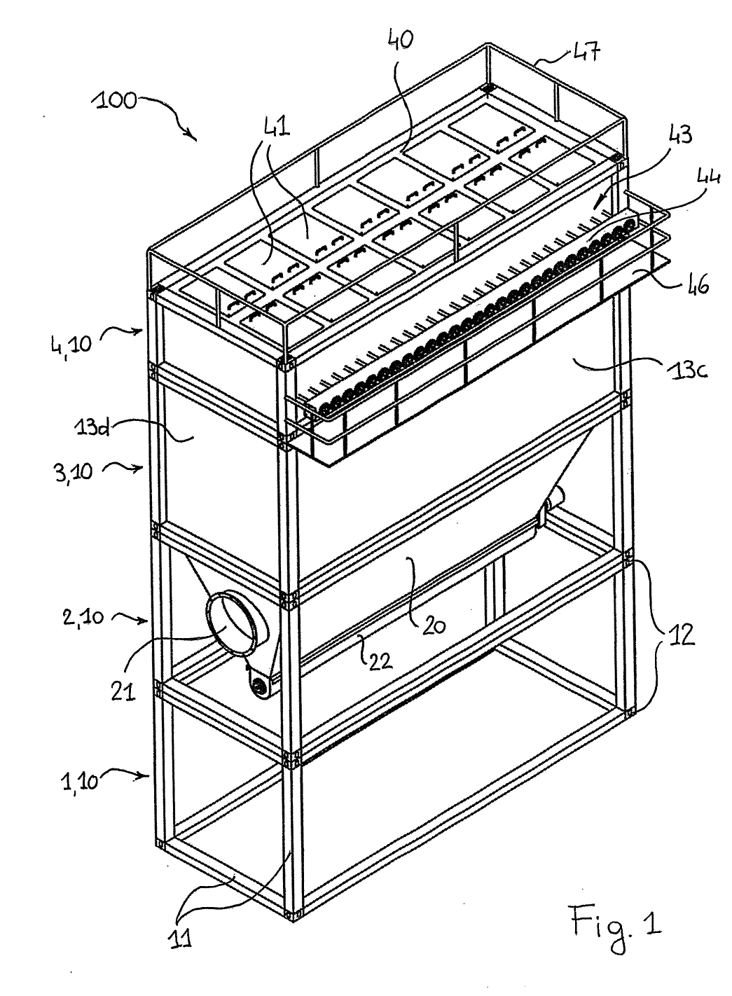

The correspondence between functional modules and freight containers from which they are structurally obtained can be chosen at will, on the basis of the construction requirements. FIGS. 1-3, 5, 7, and 9 show embodiments of the bag filter 100 in which each functional module 1-4 has a respective structure entirely obtained from a respective freight container 10. Alternatively, it is foreseeable that one or more functional modules 1-4 have a respective structure obtained from two or more freight containers 10, as in the case of the filtration module 3 of the embodiment shown in FIG. 4, which is obtained from two freight containers 10. In a further variation of the invention, it is foreseeable that one or more functional modules 1-4 have a respective structure obtained from a same freight container 10.

Preferably, the freight containers 10 have a parallelepiped or cubic shape, comprising a plurality of frame members 11 assembled with each other by means of corner fittings 12, in such a way as to define a framework of the freight container, and a plurality of enclosure walls 13 arranged between the frame members 11 and forming an enclosure of the freight container. Usually, among the enclosure walls 13 it is possible to functionally distinguish a base 13a, a roof 13b, a pair of opposing side walls 13c a front wall 13d, normally provided with an access to the freight container, and a rear wall 13e, opposed to the front wall 13d.

More preferably, the freight containers 10 are freight containers conforming to the ISO (International Organisation for Standardization) 1496 standard, i.e. freight containers having a framework with 12 frame members assembled with each other by means of corner fittings, which in turns conform to the ISO 1161 standard, and having characteristic dimensions (usually height and/or length) within predetermined ranges.

Alternatively, the freight containers 10 can be freight containers conforming to the ISO 1496 standard, i.e. freight containers having a framework with 12 frame members assembled with each other by means of corner fittings, which in turn conform to the ISO 1161 standard, but having characteristic dimensions that do not conform to the ISO 1496 standard.

In general, the structural modifications to be performed on the freight containers 10 differ depending on the functional module to be obtained from them.

Preferably, the structures of the functional modules 1-4 comprise at least the frame members 11 and the corner fittings 12 of the freight container or containers 10 from which they are obtained.

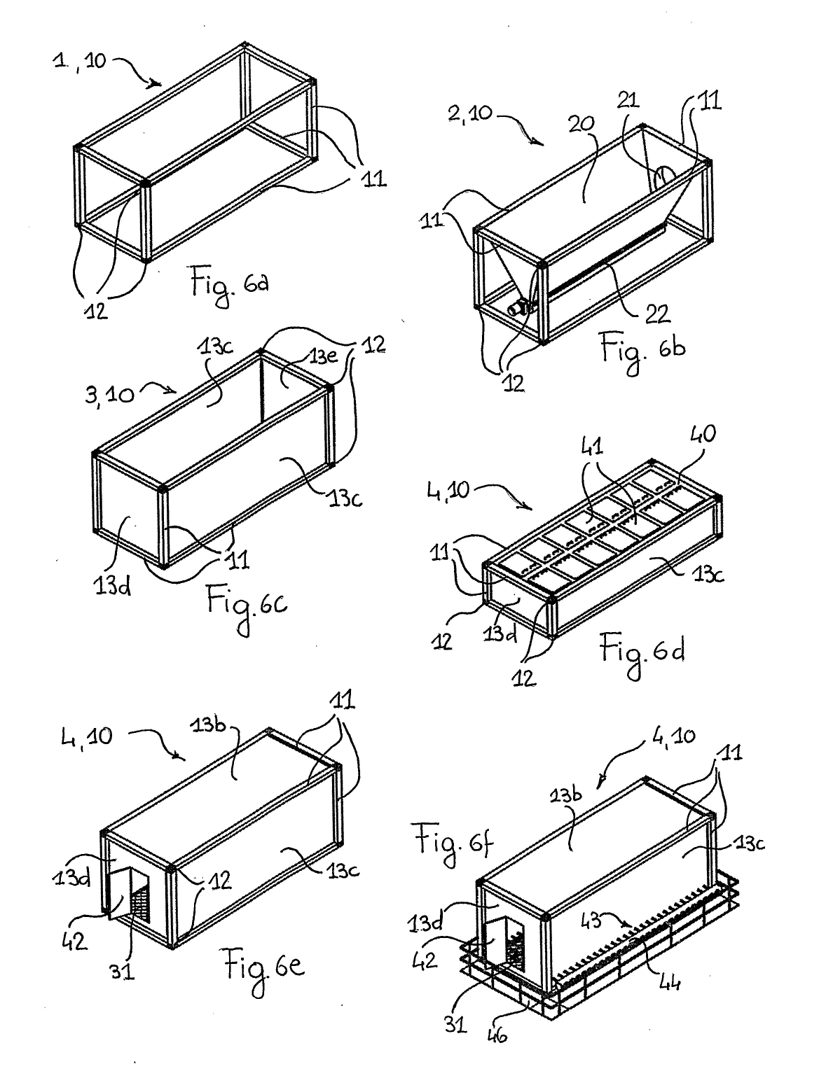

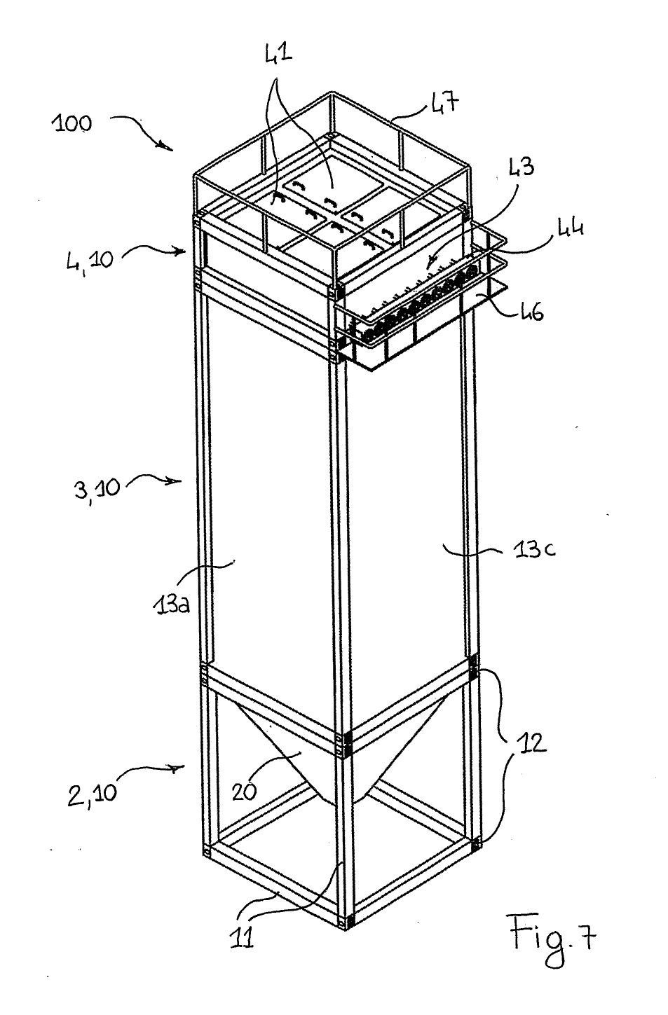

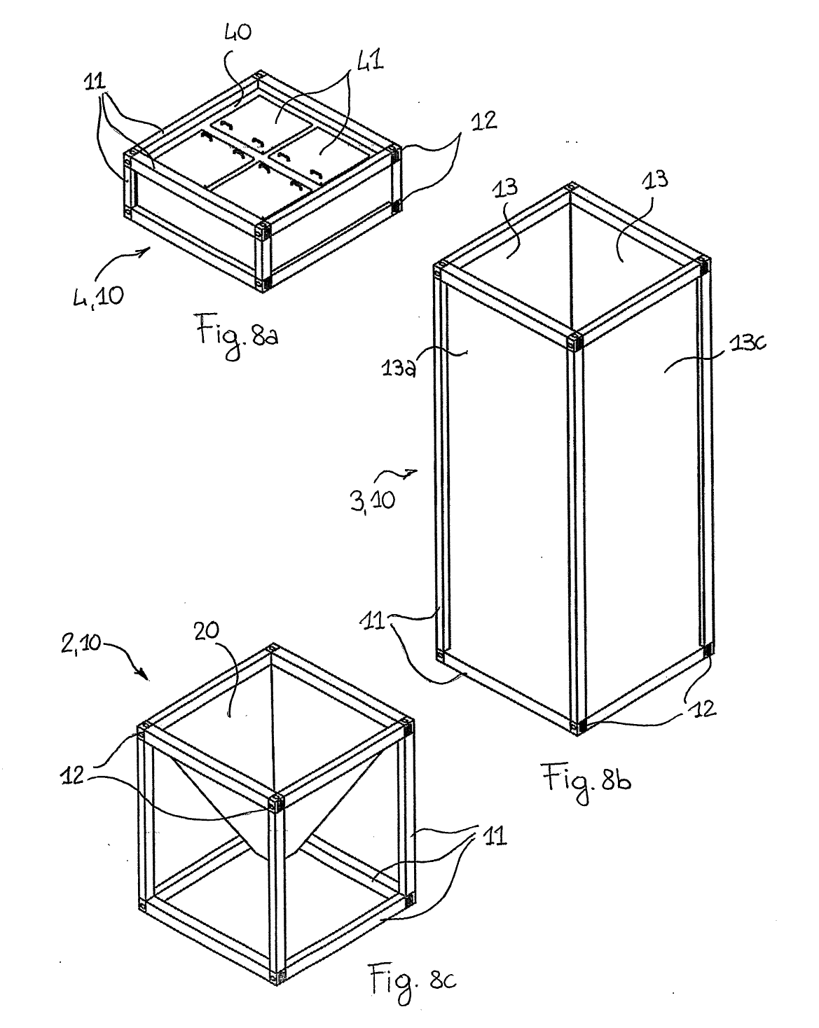

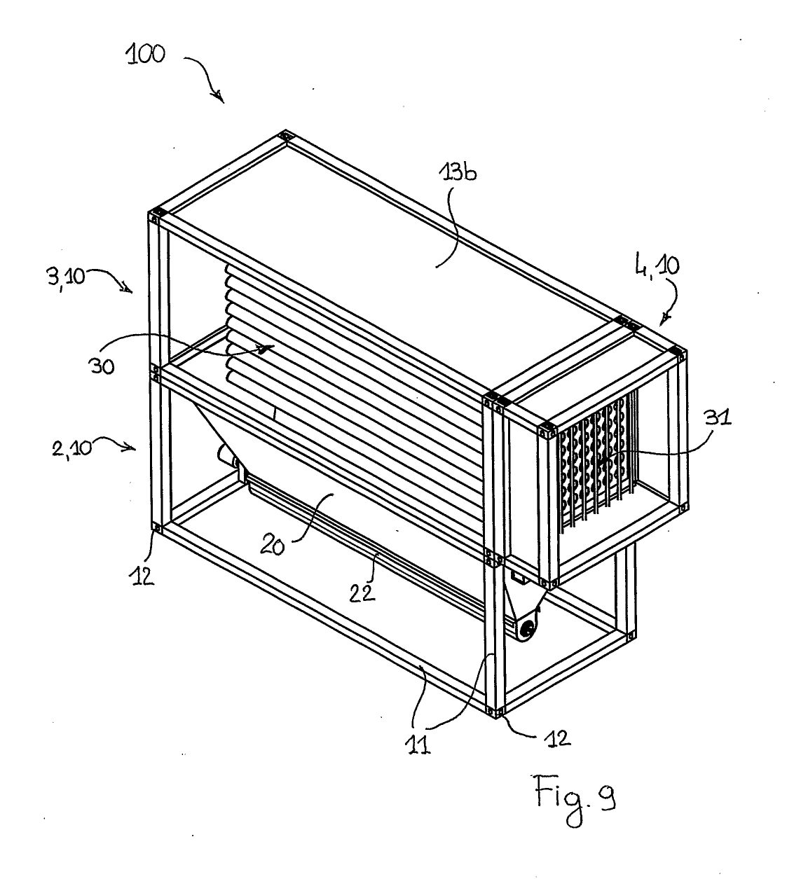

FIGS. 6a-6f and 8a-8c show preferred embodiments of the functional modules 1-4 obtained from freight containers 10. With the exception of the embodiments of FIGS. 6d, 8a and 8c, the freight containers 10 employed to obtain the functional modules 1-4 in these examples conform to the ISO 1496-1, in the dimensional type 1C.

In particular, FIG. 6a shows a support module 1a, the structure of which preferably consist of the framework a freight container 10, i.e. of only the frame members 11 and the corner fittings 12. If desired, one or more of the original enclosure walls 13 can be retained and/or reinforcing elements, such as, for example, bracing, stiffeners or ribs, can be added to increase the rigidity of the module. The support module 1 is usually employed at the base of the bag filter 100 (FIGS. 1-5), but can also be omitted (FIG. 7), for example when pillars provided at the installation site are used.

FIG. 6b shows a dust collection module 2 with a collection hopper 20. The structure of this module is also based on the framework of a freight container 10. Preferably, the collection hopper 20 has respective walls directly attached, by means of welding or mechanical fastening, to the frame members 11 defining the perimeter of a face of the freight container 10.

At any of the walls of the collecting hopper 20 a flange 21 is formed for connecting a inlet tubing of the gaseous substance (not shown). The collection hopper 20 is also preferably provided with extraction means 22 for the collected dust, in this case of the screw type. However, different types of extraction means can be used, all known to a man skilled in the art, such as for example drag conveyors, sluices valves of the single or double flap type or of the rotary type, fluidized conveyors, dust scrapers.

Another dust collection module 2, different in morphology but conceptually analogous to that of FIG. 6b, is shown in FIG. 8c.

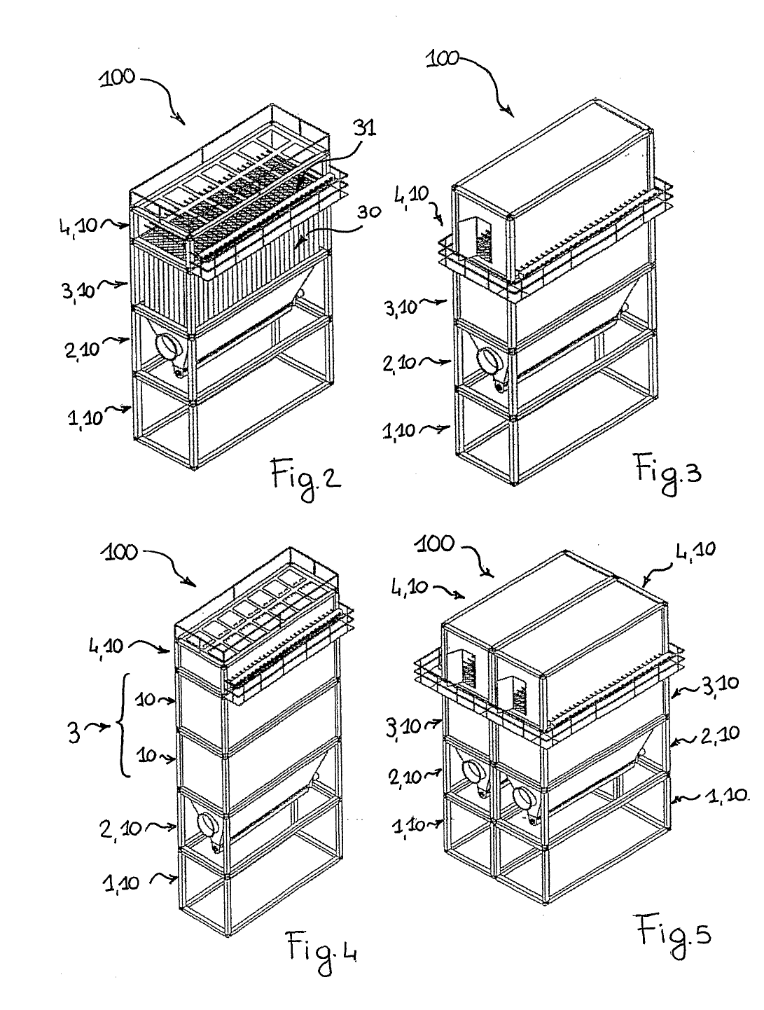

FIG. 6c shows a filtration module 3 adapted to house a plurality of filtering bags 30, which are visible in detail in the views with partially removed parts of FIG. 2 and FIG. 9. The structure of this module is obtained from a freight container 10 preferably by removing two enclosure walls 13 in order to provide a fluid communication to the functional modules 2 and 4 and, at the same time, to define a lateral enclosure for the filtering bags 30.

The choice of the enclosure walls 13 to be removed is determined by the assembly mode of the functional modules 1-4 and/or by the arrangement of the filtering bags 30 inside the filtration module 3.

If the functional modules 1-4 are to be superimposed in a horizontal position (direction of superposition of the modules parallel to a transverse axis of the freight containers 10), and if the filtering bags 30 are arranged vertically in the filtration module 3 (longitudinal axes of the filtering bags parallel to the direction of superposition of the modules), as in the embodiments of the bag filter 100 shown in FIGS. 1-5, the base 13a and the roof 13b of the freight container 10 are removed (FIG. 6c). If the functional modules 1-4 are to be superimposed in a vertical position (direction of superposition of the modules parallel to a longitudinal axis of the freight containers 10) and the filtering bags 30 are again arranged vertically in the filtration module 3, as in the embodiment of the bag filter 100 shown in FIG. 7, the front wall 13d and the back wall 13e of the freight container 10 are removed (FIG. 8a). If the functional modules 1-4 are to be superimposed in either horizontal or vertical position, but the filtration bags 30 are arranged horizontally inside the filtration module 3 (longitudinal axes of the filtering bags perpendicular to the direction of superposition of the modules), as in the embodiment of the bag filter 100 shown in FIG. 9, two generic adjacent enclosure walls 13 of the freight container 10 are removed.

In each of the aforementioned configurations, if the length of the filtering bags 30 requires it, it is possible to obtain the structure of the filtration module 3 from two or mode freight containers 10 (FIG. 4).

The filtering bags 30 are normally connected to a suitable bag plate 31. If the bag plate 31 is associated with the filtration module 3, this is preferably directly attached, by means of mechanical fastening or welding, to the frame members 11 defining the perimeter of one of the faces of the freight container 10, after removal of the corresponding enclosure wall 13.

FIGS. 6d-6f and 8a show different embodiments of a plenum 4. The structure of this module is obtained from a freight container 10 preferably by removing one or two opposing enclosure walls 13, in order to provide a fluid communication to the filtration module 3 and, if necessary, a suitable equipped wall for the inspection of or the access to the plenum 4. Also in this case, the choice of the enclosure walls 13 to be removed is determined by the assembly mode of the functional modules 1-4.

In particular, FIGS. 6d and 8a show a first embodiment of the plenum 4, in which the base 13 (not visible in the views of these figures) and the roof 13b of the freight container 10 are removed. Instead of the roof 13b, an upper wall 40 is provided, equipped with one or more hatches 41 for the inspection of the plenum 4 and of the filtering bags 30, as well as for mounting or extracting the same. FIGS. 6e and 6f show another embodiment of the plenum 4, having dimensions suitable for allowing access of personnel inside it. Access takes place by means of an access door 42, either already existing in the freight container 10 or purposely created in one of the enclosure walls 13 of the same. In this case, only one of the enclosure walls 13, normally the base 13a, is removed, while other walls may be structurally modified for specific purposes.

Independently of the specific embodiment of the plenum 4, the bag plate 31 can be associated with this module, rather than with the filtration module 3. Also in this case, the bag plate 31 is preferably directly attached, by means of mechanical fastening or welding, to the frame members 11 defining the perimeter of one of the faces of the freight container 10 from which the corresponding enclosure wall 13 has been removed (FIGS. 6e and 6f).

Preferably, the plenum 4 includes a compressed air distribution system 43, used for cleaning the filtering bags 30. The compressed air distribution system 43 typically comprises a collector to which a plurality of blowing pipes are connected and can be partially or wholly housed in the freight container 10 from which the plenum 4 is obtained. As a way of example, FIG. 6f shows an embodiment of the plenum 4 in which the compressed air distribution system 43 comprises a collector 44 external to the freight container 10, and internal blowing pipes 44 (not shown).

The plenum 4 is preferably further provided with external gangways 46 and/or handrails 47, providing the necessary access thereto in conditions of safety (FIGS. 1-5, 6f, 7). These components are preferably directly attached to the frame members 11 of the freight container 10 from which the plenum 4 is obtained.

At one or more of the walls of the plenum 4 flanges (not shown) are further provided for connecting discharge tubings of the filtered gaseous substance (again, not shown).

As in the case of the filtration module 3, if necessary the structure of the plenum 4 can be as well obtained from two or more freight containers 10.

In addition to the functional modules 1-4 described above, a covering module (not shown) can be optionally provided, adapted to define an at least partially closed environment at the upper wall of the bag filter 100, for allowing inspection and maintenance operations to be carried out whilst sheltered from the elements. The structure of this additional functional module can be as well obtained at least partially from a freight container 10, in ways similar to those explained above with reference to the functional modules 1-4.

FIG. 5 shows an embodiment of the bag filter 100 in which two units, assembled with functional modules 1-4 described above, are arranged in parallel so as to treat a greater flux of gaseous substance. In this case, it is possible to eliminate one or more enclosure walls 13 at the interface between the two units, or it is possible to obtain from the beginning the structure of one or more of the functional modules 1-4 from pairs of freight containers 10 arranged side by side.

With reference to the preferred embodiments of the bag filter 100 described above, a preferred way of carrying out the method of the invention for constructing a bag filter shall now be described.

The method essentially comprises a first step of providing the functional modules 1-4 and a second step of suitably assembling these modules to obtain the bag filter 100.

The provision of the modules can take place either in the workshop or at the site where the filter is to be installed. The assembly of the modules preferably takes place at the site where the filter is to be installed.

According to the invention, the step of providing the functional modules 1-4 comprises a step of structurally modifying at least partially one or more freight containers 10 in such a way as to obtain the structure of one or more of such functional modules 1-4.

As described with reference to FIGS. 6a-6f and 8a-8c, the step of structurally modifying the freight containers 10 preferably comprises removing partially or totally, replacing or modifying at least one of the enclosure walls 13 thereof.

Depending on the type of functional module and/or on the specific requirements, the step of structurally modifying the freight containers 10 may comprise applying structural reinforcement elements, such as for example bracing, stiffeners or ribs, and/or coupling elements, such as for example coupling flanges, possibly provided with sealing elements, for the subsequent assembly in the bag filter 100.

The step of structurally modifying the freight containers 10 may further comprise the provision, internally and/or externally to the freight container 10, of auxiliary devices of the bag filter 100, such as, for example, compressed air distribution systems, ladders, gangways and/or hatches for access and inspection, handrails, lighting devices, control devices. Whenever possible, this auxiliary devices are preferably attached to frame members 11 of the freight containers 10.

If required, one or more functional modules 1-4 can be provided with thermal insulation, by applying pre-insulated walls in addition to or as a replacement for enclosure walls 13 of the respective freight containers 10, or by applying insulating material internally or externally thereto.

The step of assembling with each other the functional modules 1-4 preferably comprises arranging these functional modules in series and/or in parallel with each other with respect to the direction of a filtration flow in the bag filter.

Preferably, the functional modules 1-4 are juxtaposed so that the corner fittings 12 of the respective freight containers 10 are in contact with each other.

Preferably, moreover, the step of assembling with each other the functional modules 1-4 comprises structurally securing the functional modules 1-4 to each other and airtight sealing joint portions between the functional modules 1-4. The structural securing is preferably obtained by means of mechanical fastening or welding at facing corner fittings 12. The airtight sealing is preferably obtained by welding at facing frame members 11 or by providing welded joint coverings and/or coupling flanges, welded or mechanically fastened, which may comprise gaskets.

1. A bag filter structure comprising:
a plurality of modules associated with each other and adapted to support respective functions in the bag filter structure;
at least one of said modules being a structure obtained at least partially from a freight container.

2. The bag filter structure according to claim 1, wherein each of said one or more modules is a structure obtained at least partially from a respective freight container.

3. The bag filter structure according to claim 1, wherein at least one of said one or more modules is a structure obtained at least partially from two or more freight containers.

4. The bag filter structure according to claim 1, wherein at least two of said one or more modules is a structure obtained at least partially from a single freight container.

5. The bag filter structure according to claim 1, wherein said one or more of said freight containers have a parallelepiped or cubic structure comprising a plurality of frame members assembled with each other by corner fittings to define a framework of the freight container, and enclosure walls arranged between said frame members to form an enclosure of the freight container.

6. The bag filter structure according to claim 5, wherein said one or more freight containers are freight containers conforming to the ISO 1496 standard.

7. (canceled)

8. The bag filter structure according to claim 5, wherein the respective structures of said one or more modules comprise said frame members and said corner fittings.

9. The bag filter structure according to claim 8, wherein the respective structures of said one or more modules further comprise at least one of said enclosure walls.

10. The bag filter structure according to claim 1, wherein the deployment of any one module of said plurality of modules is selected from the group comprising:
a support module, a dust collection module, a filtration module, and a collection modules for the filtered gaseous substance.

11. The bag filter structure according to claim 5, wherein at least one of said one or more modules is a dust collection module comprising a collection hopper, and said collection hopper has respective walls attached to frame members defining the perimeter of a face of one of said one or more freight containers.

12. The bag filter structure according to claim 5, wherein at least one of said one or more modules is a filtration module or a collection module for the filtered gaseous substance comprising a bag plate for the connection of filtering bags, and said bag plate is attached to the frame members defining the perimeter of a face of one of said one or more freight containers.

13. The bag filter structure according to claim 5, wherein at least one of said one or more modules is a collection module for the filtered gaseous substance comprising a compressed air distribution system, and said compressed air distribution system is housed partially or entirely inside one of said one or more freight containers or is externally associated with it.

14. The bag filter structure according to claim 1, wherein at least one of said one or more freight containers is provided with auxiliary components of the bag filter, selected from the group comprising:
ladders, gangways and/or hatches for access and inspection, lighting devices, control devices.

15. A method for constructing a bag filter comprising a plurality of modules associated with each other and adapted to perform respective functions in the bag filter, said method comprising the steps of:
structurally modifying at least partially one or more freight containers to obtain the structure of one or more modules of a plurality of modules;
assembling the modules with each other to form a bag filter structure.

16. The method according to claim 15, wherein said one or more freight containers have a structure substantially parallelepiped in shape comprising a plurality of frame members assembled with each other by corner fittings in such a way as to define a framework of the freight container, and enclosure walls arranged between said frame members to form an enclosure of the freight container, and wherein said step of structurally modifying at least partially one or more of the freight containers comprises removing partially or totally, replacing or modifying at least one of said enclosure walls.

17. The method according to claim 15, wherein said step of structurally modifying at least partially one or more freight containers comprises applying structural reinforcement elements or coupling elements.

18. The method according to claim 15, wherein said step of structurally modifying at least partially one or more freight containers comprises providing internally or externally to said one or more freight containers auxiliary devices of the bag filter.

19. The method according to claim 15, wherein said step of assembling with each other the modules comprises the step of:
arranging said modules in series or in parallel with each other with respect to the direction of a filtration flow in the bag filter.

20. The method according to claim 19, wherein said step of assembling with each other the modules further comprises the steps of: structurally securing said modules to each other, and airtight sealing joint portions between said modules.

21. A bag filter structure comprising:
a plurality of support modules, each of said support modules being comprised of a freight container, each of said freight containers being modified to remove at least one portion of at least one side of said freight container;
at least two of said support modules being assembled into a bag filter frame, each of said support modules being deployed to support a bag filter component comprising one of a support module, a dust collection module, a filtration module or a collection module.
